(19) United States
(12) Patent Application Publication
(10) Pub. No.: US 2006/0178938 A1
(43) Pub. Date: Aug. 10, 2006

(54) Method and system for giving

(76) Inventor: Gillian Leslie Wallace, Queensland (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/561,555

(22) PCT Filed: Jun. 21, 2004
(86) PCT No.: PCT/AU04/00816

§ 371 Date: Dec. 20, 2005

(30) Foreign Application Priority Data
Jun. 20, 2003 (AU) 2003903156
Mar. 31, 2004 (AU) 200401746

(51) Int. Cl. G06Q 30/00

(52) U.S. Cl. 705/26

(57) ABSTRACT

Methods and systems for giving are disclosed. A primary procedure, instigated by a user in an electronic environment is detected. A secondary financial procedure, preassociated by the user with the instigated primary procedure is then determined. Data is automatically generated for output representing instructions to cause the secondary financial procedure on detection of the instigated primary procedure.

### field of the invention

The present invention relates to methods and systems for giving as a secondary procedure, when a primary procedure, not ordinarily related to giving, is carried out.

### BACKGROUND OF THE INVENTION

E-philanthropy is a reference to the application of philanthropic mechanisms to an electronic environment, and in particular to e-commerce and e-business. E-philanthropy has been in existence in one form or another since the late 1990s with numerous organizations having “click-and-give” donation facilities active on their websites. One of the problems with these existing mechanisms is that many people are unaware of the websites, and many will often not think or wish to visit a specific website to make a philanthropic donation. The present invention is based on the premise that the more user-friendly and convenient a transfer, such as e-philanthropy can become, the more likely it will be adopted as a tool for giving. Preferred forms of the present invention are therefore concerned with providing more user friendly and more convenient e-philanthropy methods and systems.

The present invention has application to what will be herein referred to as micro-commerce, which is conveniently defined as an umbrella term that includes micro-banking, micro-payment and micro-saving, and, in a particular form, “micro-philanthropy”. Micro-philanthropy may be understood as the making of a number of small and apparently inconsequential donations over a period of time, such that a large number of these small donations combine to constitute a relatively substantial philanthropic contribution. The giving may be to another person, or may be a means of transferring money between different accounts of a single person, e.g. where a savings account or holiday fund has been set up. The giving may still be said to be to a philanthropic cause in these cases. Also in these cases, the premise that the more user friendly and convenient the transfer process becomes, the more utilised it will be is still true.

Credit and debit card payment are among the most convenient forms of payment for goods and services, and are widely used at vendors throughout many parts of the world. Donation to philanthropic causes is a subject that is often thought of by individuals, but one of the problems faced by such causes is that the thought is not always put into action by way of an actual donation.

Credit cards that allow an amount to be donated to charity, in a so called points system are possible, where points are earned by use of the credit card to purchase goods and/or services from vendors, typically at the end of a predetermined period. However, firstly, the choice of charities associated with such cards is often small and, secondly, the chosen charity does not necessarily reflect the desires of the credit card user at the time of payment due to the delay between the payment and the receipt of the points. This may discourage users from making charitable donations, and the users may instead decide to use the points acquired through the credit card use for other purposes, e.g. Air Miles (TM).

The present invention will hereafter be described in this exemplary context, although it will be appreciated that the invention is not limited to the making of small donations or contributions.

### SUMMARY OF THE INVENTION

Viewed from a first aspect, the present invention provides a method of giving, the method comprising detecting an instigated primary procedure, instigated by a user in an electronic environment, determining a secondary financial procedure, preassociated by the user with the instigated primary procedure, and automatically generating for output data representing instructions to cause the secondary financial procedure on detection of the instigated primary procedure.

A plurality of preassigned primary and secondary procedures may be available. In one embodiment, each secondary financial procedure is preassociated by the user with at least one preassigned primary procedure.

In a form of the first aspect of the invention, the primary procedure is an action or a script of actions on a computer, the execution of which is initiated by a user event, such as a mouse click, pressing a key, or a voice command. The primary procedure may be one that is performed by the user on a relatively frequent basis. For example, the primary procedure may comprise any one or more of: sending an email, making an internet connection, conducting an internet transaction, creating a new word-processing document, downloading a file, reception of audio and/or video broadcast, entering a security password to access files or to access a network, creating a new word-processing document or being connected to the internet for a predetermined period of time. In relation to this last example, the computer's clock may play a part in the step of triggering or activating the secondary procedure. The primary procedure may also be a security response, such as iris, palm or fingerprint recognition, or any other user action in the electronic environment. The primary procedure is therefore an action or a script of actions executed at the discretion of the user, and the execution of the primary procedure is typically initiated by a user event, such as a mouse function, pressing a key, or voice command etc.

The primary procedure need not be carried out on a computer; the primary procedure may be instigation, or completion, of a telephone call, e.g. using a mobile telephone. Additionally, the primary procedure may be sending or receiving a Short Message Service message or “Text message” on the telephone. The secondary procedure may be, for example, to send a further text message to a predetermined number causing a charge to be made to the user to a recipient unconnected to the entity involved in the primary procedure. The secondary procedure may be allocation of funds to a recipient whenever a particular preselected number is called, the calling of a particular number being a particular primary procedure.

The primary procedure and secondary procedure may be with the same entity. Different primary procedures may also be allocated to the same secondary procedure. In an embodiment, the primary procedure performed by the user is itself not commercial in nature; i.e. it is not a commercial or financial transaction.

In a form of the first aspect of the invention, the primary procedure operable to activate the secondary procedure is the sending of an email, and a stamp or logo is incorporated within the email (for example, at the foot of the email) to make the recipient of the email aware that a donation has been made.

In a form of the first aspect of the invention, the secondary procedure involves an allocation of a predetermined contribution to a recipient, such as a charity. Accordingly, the method furthermore preferably includes selecting or nominating the particular recipient, to which the contribution is to be allocated during the secondary procedure. The contribution is typically a financial contribution in the form of a monetary pledge or donation.

In a form of the first aspect of the invention, the secondary procedure involves allocating a contribution of predetermined value to a recipient, such as a relative, or the user; for example a financial contribution to a bank account. In the case of such a recipient, an amount to be transferred at each occurrence of the primary procedure may be selected. The particular person receiving the contribution may also be selected.

In a form of the first aspect of the invention, the method includes the step of selecting or nominating the value of the contribution to be allocated during each execution of the secondary procedure. The contribution allocated in each execution of the secondary procedure is most typically a nominal or small amount of money, since it will preferably be allocated on a relatively frequent basis. For example, a nominal predetermined value contribution may be in the range of about 5 cents to about one dollar. The present invention does, however, also contemplate higher and lower contribution values.

The amount of financial contribution of the secondary procedure, when activated by different primary procedures may be different, e.g. when the computer is turned on, or a user logs on, a relatively large contribution is made, whereas, when the word processor is run (a procedure that may be instigated many times in a single session) a smaller amount is contributed.

Different types of secondary procedures may be combined, either for a single primary procedure, or different types of secondary procedure for different primary procedures. For example, a number of secondary procedures may be combined with a single primary procedures; giving to more than one recipient may be achieved with a single instance of the primary procedures.

In a preferred form of the invention, the method includes establishing or identifying more than one said primary procedure associated with the secondary procedure. Similarly, the method may also include the step of associating more than one said secondary procedure with the primary procedure(s), such that operation of each primary procedure is adapted to activate at least one of the secondary procedures.

In a form of the invention, the method includes enrolling or subscribing the user. This enrolling or subscribing is typically performed by the user him/herself, and includes the logging of personal details of the user, such as name and address. The enrolling or subscribing typically also includes nominating the one or more recipients, to be the subject of the donations, determining the value of each allocated contribution, and selecting a mode of payment to be used to ultimately transfer the funds to the recipient(s). For example, the mode of payment may be by credit card, or by direct debit from a savings or other account. In such a case, the enrolling or subscribing step typically also includes logging of bank or financial institution account details to authorise such a transaction.

One form of the first aspect of the invention is designed to allow a user to enrol or subscribe by, for example, entering his or her personal details, nominating one or more recipients, to be the subject of the donations or contributions, determining the value of each allocated contribution, and selecting a mode of payment to a designated holding account of the or each recipient. For example, the mode of payment may be by credit card, or by direct debit from a savings or other account. Accordingly, the system is preferably adapted to allow the user to enter banking or account details to authorise a payment transaction.

In one form of the invention, the system includes a multi-function transfer procedure (MFTP) for the automated transfer of funds from a specified account into another or several other specified accounts when triggered by operation of the primary procedure. That is, the MFTP is adapted to recognise the operation of the primary procedure and to activate the secondary procedure. The secondary procedure may involve an automatic and instantaneous electronic transfer of each individual contribution to a specified account for the recipient. Alternatively, all of the contributions may be transferred to a single centralised account along with data identifying the particular recipient, to which the amounts are ultimately to be directed.

In one form, the first aspect of the invention optionally also includes means for making one-off contributions. For example, a specific icon-type “button” may be provided, adapted to be displayed for the user on a computer's desk-top, start menu or home-page. By selecting this action (e.g. by “clicking” this button), the user may be provided with the option for “instant giving” in one-off donations to the one or more pre-selected recipients, e.g. philanthropic causes. In a preferred form of the first aspect of the invention, an icon-type “button” may be displayed on the computer desk-top, which button is adapted to operate as a trigger such that the user clicking the trigger button activates the secondary procedure. The system is preferably adapted to display the trigger button regardless of which program the user may be currently operating.

In a preferred form of the first aspect of the invention, the MFTP is adapted to provide the user with an opportunity to pause, cancel or otherwise vary the electronic transfer, prior to the transaction actually taking place. In this regard, the system may cause a symbol or icon to appear on a computer screen of the user, and by clicking on this symbol the user may alter or confirm details of the transfer. Furthermore, the user may be required to enter a pre-selected personalised security code before the electronic transfer of funds is able to proceed.

In a form of the invention, the system is adapted to maintain a record of the various individual contributions made by the user. That record may preferably be accessed and reviewed by the user at any time.

Viewed from a further form, the primary procedure is a financial procedure, which may be a primary fund transfer. The primary procedure may be a purchase from an entity. Additionally, the secondary financial procedure may be an auxiliary fund transfer.

The association of primary procedures and secondary financial procedures may be made by association, for example, in an association database, of particular entities, goods, and/or services to receive a primary fund transfer with particular recipients to receive an auxiliary fund transfer.

An entity may be a vendor of particular types of goods or services. A recipient may be an individual, and may be the user/customer. In a further possible form, the recipient may be a commercial organisation, or government department. The auxiliary fund transfer may be commercial in nature, or may be based on self-interest.

Preferably, the system and method are available to multiple users, and are individually configurable by each user. The system and method may be configured for each individual user, rather than directly by them. Preferably each user can only make use of data associated with that user.

In one form, the association database holds data representing an association of at least one good, service or entity with at least one recipient for at least one user. Preferably, the association of entities, goods and/or services with recipients is customised to each user and is predetermined by the user. Typically, the user may associate many entities, goods and/or services with a single recipient, and/or the user may split the auxiliary transfer for a particular entity, good or service between at least two recipients in proportions also determined by the user. Therefore, the system preferably includes a user interface to allow users to update, amend or configure the data held in the association database to update change or configure recognised goods, services and/or entities and update, amend or configure recipients that will receive auxiliary transfers, together with configuring the associations between various goods, services or entities and various recipients for each particular user. This configuration is preferably carried out by a user separately to a primary procedure by that user. However, it is possible for the user to be requested to choose a recipient to receive the auxiliary fund transfer at the time of making the primary procedure, preferably from data held in the association database.

In a form of the invention, the user is also allowed to select or nominate the value of the contribution to be allocated to each particular recipient during each execution of a secondary procedure, such as an auxiliary fund transfer. The association database may cross-reference types of good, service and/or entity against various recipients to receive auxiliary fund transfers upon purchase of the particular good or service or amount spent at a particular entity. Therefore, allocation data may be held in the association database, being configurable by the user, the data representing the amount of the contribution, or a predetermined fraction of the value of the good/service purchased or amount spent at the vendor. The allocation data may be held in the association database, or may be held in a separate database, either within the system or remote from it. One or more association databases may be held by one or more entities. One or more association databases may be held by financial institutions responsible for effecting payments, or primary fund transfers, to honour purchases made by the user.

Preferably, both the primary and secondary procedures are transfers debited from a single account of a user/customer. Alternatively, the primary and secondary procedures may be debits from separate accounts of a single user/customer. Alternatively, the secondary procedure may be a transfer from a third party account, such as an account from a donor, who has approved auxiliary transfers of funds when the user/customer makes a primary fund transfer or purchase of a predetermined type and or amount.

In an alternative, the financial primary procedure may be a receipt of funds by a user rather than a payment by the user. In this way when a primary procedure is received by a user, and an auxiliary transfer is made from the user to a recipient. For example, the user may receive payment for a particular good or service and may make an auxiliary transfer associated by the user with that good or service. The user may make an auxiliary transfer based on the instigator of the financial primary procedure, or the amount of the financial primary procedure, in which case the association database holds associations between entities and recipients where the entities are purchasers rather than vendors.

Two auxiliary fund transfers may occur for a single primary fund transfer or purchase. An auxiliary fund transfer may occur both when a first user transfers money, as a primary procedure, to a second user, and when the second user receives the money from the first user. In this case, the two auxiliary fund transfers originate from different users.

The primary procedure may be a financial primary procedure from the user for payment in regard to at least one entity, good or service. For example, the good purchased in the primary procedure may be groceries or dining out, and the recipient associated with this type of primary procedure could be a donation to, one or more particular famine relief charities; doctor bills as the primary procedure may cause an auxiliary transfer to a medical research group, or, alternatively, to a private health fund, or a user account set up to save money for private health; purchase of pharmaceutical products may cause an auxiliary transfer to specific medical research; purchase of petrol from a petrol station may redirect to charities working towards green alternatives to such fuels.

Alternatively, where the auxiliary transfer is to a separate account of the user, this aspect of the invention may be used for micro-saving purposes, for example, if the primary procedure is the purchase of baby clothes for a child, the auxiliary transfer may be to a savings account or trust for the future education of the child; if fuel is purchased, the auxiliary funds may go to a savings account for a new car etc. Alternatively, the auxiliary fund transfer recipient may be a relative or friend of the user, and primary goods or services may be linked to an account held by the relative or friend. For example, in this case, the payment of a telephone bill by the user may cause an auxiliary fund transfer to the account of a son/daughter of the user. In addition, the auxiliary fund transfer may be in the form of a credit acquisition to the vendor or service provider. In this case, the auxiliary transfer may be for future usage, service or content. In these forms the giving may be said to be altruistic, or philanthropic.

The entity may be a vendor of goods and/or services. The goods or services may be determined by the system by the nature of the entity that sold them; purchases from a petrol station would then indicate purchase of petrol. The good/service determination may be done by the association database, i.e. the association database cross references entities with recipients, or there may be a further database to associate entities with particular goods or services. Such categorisation may ease the determination by the system of the particular good or service, as only the details of the entity need be known to the system, rather than the particular purchase made within entity's offered items. The database may be stored at the financial institution and the details may be merchant ID and/or bank code and account number, indicating a particular payee. However, the goods or services may be the particular items sold by the vendor where data representing the particular items is available to the system and the system is adapted to cross reference those goods and services with a determined recipient.

If the association database does not contain details of association for a particular entity, such as an entity, good or service, the system may make an auxiliary fund transfer to a recipient associated with ‘no entry’ in the database under goods/services/entities. Alternatively, if no entry exists in the database for a particular entity, good or service, no auxiliary transfer may be made. As a further alternative, in the case where the primary procedure is the purchase of individual goods and/or services from an entity, if no entry exists for a particular good or service, a transfer based on the whole value of the transaction with the entity may be applied.

Preferably, the allocation of the auxiliary fund transfer occurs at substantially the same time as the associated primary procedure. The primary fund transfer may be use of a credit or debit card or the like, or on-line as an e-payment, or may be a direct debit payment.

In an optional form of the invention, the allocation data is always output to a single receiver, such as a Public Interest Trust, and includes data representing the determined recipient. The receiver may then perform incremental storage of the allocations and may periodically transfer sums to each determined entity. Alternatively, the receiver may receive the auxiliary fund transfer at the time of the associated primary procedure and keep the money in a trust before transferring it to the determined recipient. In this case the interest earned on the auxiliary funds held by the trust can be used to cover running and other costs of the system. Further a combination of these two operations may be combined.

The system and method may process and perform the actual primary procedure and the auxiliary fund transfer itself; the system and method may be operated by the credit card company, bank etc. of the user. Alternatively, the system may receive data indicating that the primary procedure is taking place together with data identifying e.g. the user, the good/service or vendor and amount of purchase (if the allocation is purchase amount dependent), and may either instigate the auxiliary fund transfer itself, or output data instructing the auxiliary fund transfer to be carried out by a third party, for example by the credit card company of the user.

The auxiliary payment may be in addition to the amount transferred in the primary procedure. However, the auxiliary fund transfer may be a designated portion of the value of the primary procedure, for example, where the credit card company of the user promises to give a fraction of each transaction to determined recipients.

In a form of the invention, the system is adapted to maintain a record of the various individual contributions made by each user. That record may preferably be accessed and reviewed by a user at any time. The system may be implemented in software, hardware or a combination of the two.

In a form of the invention, the method includes: accruing a plurality of allocated contributions up to a predetermined accrued value, and subsequently transferring a sum having the predetermined accrued value to a recipient.

A feature of embodiments of the present invention is that donations may be made despite being of only a small or nominal value. However, due to the fact that transaction fees are often incurred during electronic financial transfers, it may be preferable to only actually make a financial transfer after an accrued sum becomes significant compared to any transaction fee. In a preferred form of the invention, therefore, the system is adapted to accrue the relatively minor amounts of money into larger sums before an electronic transfer of the money occurs. In this regard, the user may preferably specify or nominate the predetermined accrued value at which electronic transfer of funds is to occur.

In one form of the invention, the step of transferring the sum occurs automatically, e.g. as an electronic transfer transaction, when the predetermined accrued value of the contributions is reached. In this regard, the user may be required to confirm or authorise actual transfer of the sum to a designated recipient. In an alternative form, however, each of the allocated contributions may be transferred to a designated holding account individually.

The contribution allocated in each execution of the auxiliary transfer is most typically a nominal or small amount of money in relation to the value of the primary procedure, since it will preferably be allocated on a relatively frequent basis. The present invention does, however, also contemplate high contribution values.

The actual auxiliary fund transfer may be executed from the user account to the determined recipient's account at substantially the same time that the primary fund transfer occurs. Alternatively, the allocation may be stored, and each such allocation arranged to increment the total stored allocation until a specific threshold is reached, at which time the actual auxiliary fund transfer occurs i.e. the system may be adapted to accrue the relatively minor allocations of auxiliary funds into larger sums before an electronic transfer of the total auxiliary fund amount occurs. In this case, preferably the system also includes a total allocation storage database to keep track of the total allocation to each recipient by each user to date. This total allocation storage database may be the same database as that which stores the individual allocation amounts for each user, as discussed above, or may be a separate database. Such an incremental allocation storage system may, for example, reduce banking or other transfer fees associated with the auxiliary fund transfer, by reducing the number of instances of actual fund transfer.

Preferably, the giving is philanthropic and the secondary financial procedure is philanthropic. The recipient may be an entity representing a philanthropic cause, in which case the secondary procedure can be said to be philanthropic. The secondary procedure preferably involves allocating a contribution of predetermined value to a philanthropic cause, such as a charity. The contribution is typically a financial contribution in the form of a monetary pledge or donation. A recipient may be a recipient representing a philanthropic cause or a recipient may itself be a philanthropic cause. Further, the philanthropic cause may be a charitable organisation, or may be the recipient of altruistic giving.

A form of the invention provides a system of primary and auxiliary fund transfer, the system including processing means for receiving and processing data and an association database containing data associating goods, services or entities with recipients, wherein the processing means is adapted to receive data representing information relating to a primary money transfer for payment of one or more goods, services or entities, determine a recipient associated with the good, service or entity using the association database, and generate for output data representing an allocation of an auxiliary fund transfer to the determined recipient.

A further aspect of the invention provides a method of giving, the method comprising detecting an instigated primary procedure, instigated by a user in an electronic environment, the instigated primary procedure being a non-commercial action on a computer, determining a secondary financial procedure, preassociated by the user with the instigated primary procedure, and generating for output data representing instructions to cause the secondary financial procedure, wherein the primary procedure is carried out to achieve an effect on the computer other than the secondary financial procedure.

A further aspect of the invention provides a method of giving, the method comprising detecting an instigated primary procedure, instigated by a user in an electronic environment, the instigated primary procedure being one of a plurality of primary procedures preassigned by the user as primary procedures, determining a secondary financial procedure, preassociated by the user with the instigated primary procedure, the determined secondary financial procedure being one of a plurality of secondary financial procedures, each secondary financial procedure preassociated by the user with at least one of the plurality of preassigned primary procedures, and generating for output data representing instructions to cause the secondary financial procedure, wherein the preassociation of primary procedures and secondary financial procedures is association of particular entities, goods or services with particular recipients in an association database.

A further aspect of the present invention provides a method of primary and auxiliary fund transfer, the method including receiving information relating to a primary fund transfer for payment of at least one entity, good or service, processing the information and determining a recipient associated with the entity, good or service using an association database, and generating for output data representing an allocation of an auxiliary fund transfer to the determined recipient.

In forms of aspects of the invention, the method is incorporated in a computer software system. More preferably, the method of aspects of the invention is incorporated in a computer software system that is designed to be installed and run on a personal computer. In this way, the software system may be made generally available to computer users both in the work place and in the domestic environment, e.g. providing the opportunity for individuals and organizations to incorporate philanthropic giving into their daily routine.

A form of the present invention provides a software system designed to facilitate giving to a recipient, the system including: a mechanism for establishing or identifying one or more primary procedures to be performed by a user within an electronic environment; and means for associating a secondary financial procedure with the primary procedure, such that operation of the primary procedure automatically activates the secondary financial procedure.

In a form of an aspect of the invention, the software system is adapted to run or operate in conjunction with a variety of other everyday software, including software for accessing the internet, sending and receiving emails, and word-processing.

A form of the present invention also provides computer readable code held on a computer readable carrier medium containing instructions for controlling a processor to carry out one or more of the methods of aspects of the invention.

A form of the invention also provides an apparatus including a storage device and a processor connected to the storage device, the storage device holding instructions for controlling the processor to carry out one or more of the methods of aspects of the invention.

A further aspect of the invention provides a system for giving, the system comprising a detecting component which detects an instigated primary procedure, instigated by a user in an electronic environment, a determining component which determines a secondary financial procedure, preassociated by the user with the instigated primary procedure, on detection of the instigated primary procedure, and a generating component which generates for output data representing instructions to cause the secondary financial procedure on determination of the secondary financial procedure.

Preferably, the system further comprises an association database to store data associating each of a plurality of primary procedures with at least one corresponding associated secondary procedure from a plurality of secondary financial procedures.

Preferably, the association database is arranged to store associations of particular entities, good or service, associated with a particular primary procedure for each of the primary procedures, with at least one particular recipient associated with a particular secondary financial procedure for each secondary financial procedure.

Preferably, the system further comprises an accumulation component which receives the instructions to cause the secondary financial procedure, and increments a counter on each such receipt.

Preferably, the accumulator is arranged to output instructions to cause a payment to be effected when the counter has been incremented by a predetermined amount.

According to a further aspect of the invention there is provided a system for giving, the system comprising a detecting component which detects at least one instigated primary procedure, instigated by a user in an electronic environment, the instigated primary procedure being a non commercial action on a computer, a determining component which determines at least one secondary financial procedure, preassociated by the user with the instigated primary procedure, and a generating component which generates for output data representing instructions to cause the secondary financial procedure, wherein the primary procedure is a procedure carried out to achieve an effect on the computer other than the secondary financial procedure.

According to a yet further aspect of the invention, there is provided a system for giving, the system comprising a detecting component which detects at least one instigated primary procedure, instigated by a user in an electronic environment, the instigated primary procedure being one of a plurality of primary procedures preassigned by the user as primary procedures, a determining component which determines at least one secondary financial procedure, preassociated by the user with the instigated primary procedure, the determined secondary financial procedure being one of a plurality of secondary financial procedures, each secondary financial procedure preassociated by the user with at least one of the plurality of preassigned primary procedures, a generating component which generates for output data representing instructions to cause the secondary financial procedure, and an association database which stores a preassociation of primary procedures and secondary financial procedures, the association being an association of particular entities, goods or services with particular recipients in the association database.

According to a yet further aspect of the invention, there is provided a method of giving, the method comprising establishing a primary procedure performed by a user within an electronic environment and associating a secondary financial procedure with the primary procedure by the user, such that the secondary financial procedure is activated on operation of the primary procedure.

Preferably, the associated primary and secondary procedures are stored in an association database.

Preferably, the method further comprises a method according to any one of the previous method aspects.

The methods and systems of aspects of the present invention are thus able to offer an alternative to the irregular giving of larger amounts, for example to philanthropic causes. In particular, when adapted to philanthropic giving, it allows a person to readily incorporate philanthropic generosity into their daily life by providing a way for that person to contribute small amounts as they purchase goods or services, whether in person, over the internet, or using a regular direct debit or accessing funds or accounts at an Automated Teller Machine (ATM).

The invention can also be utilised as a person enjoys the day-to-day use of his/her computer to access the internet, send emails, create files or such-like activity. Furthermore, by making this sort of micro-philanthropy available to individual computer users creates the potential to dramatically expand the domain of philanthropic giving.

Throughout the specification, the word “comprise” and variations of that word, such as “comprises” and “comprising” are not intended to exclude other additives, steps or integers.

### BRIEF DESCRIPTION OF THE DRAWINGS

Embodiments of the invention will now be described, purely by way of example, with reference to the accompanying drawings, in which:

FIG. 1 shows a system according to an embodiment of the invention;

FIG. 2 shows a method according to an embodiment of the invention that can be carried out on the system of FIG. 1;

FIG. 3 shows a method according to a further embodiment of the invention that can be carried out on the system of FIG. 1;

FIG. 4a shows a system for initiation for a further embodiment of the invention;

FIG. 4b shows a method for initialisation of an embodiment of the invention;

FIG. 5 shows a system for use in embodiments of the invention;

FIG. 6 shows a method of use of an embodiment of the invention;

FIG. 7 shows a method of use of a further embodiment of the invention; and

FIG. 8 shows a method of use of a further embodiment of the invention.

### DETAILED DESCRIPTION OF EMBODIMENTS OF THE INVENTION

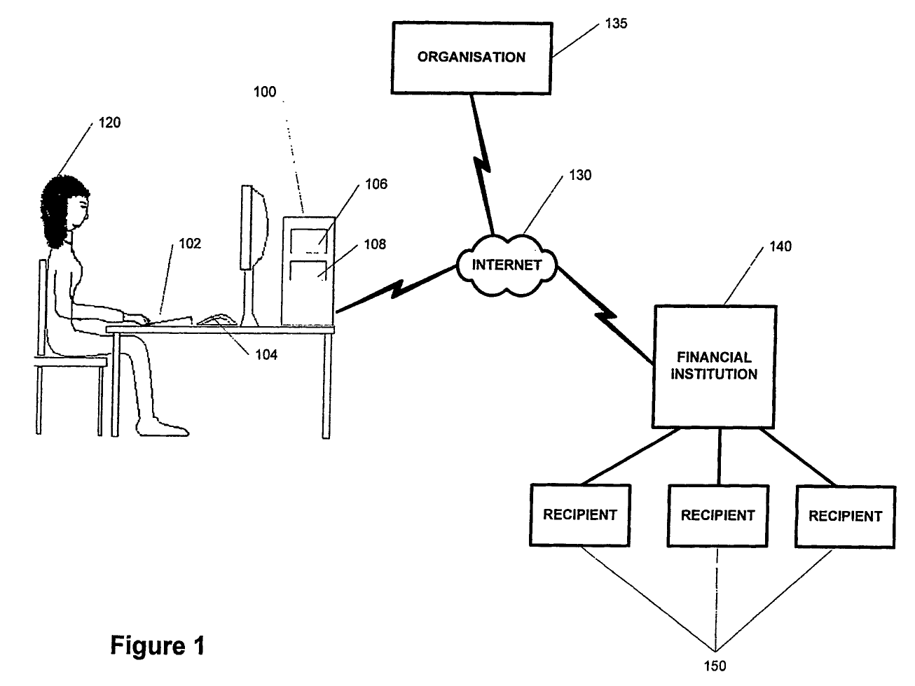

FIG. 1 shows a system including a first embodiment of the invention. The system includes a home computer 100. A user 120 interacts with the computer 100. The computer 100 is connected, via the internet 130 to an organisation 135, which holds data relating to various possible recipients. A financial institution 140 is also connected to the user via the internet. The financial institution 140, in turn, is connected to several recipients 150.

The computer 100 includes input devices of a keyboard and mouse 102, 104 for receiving inputs from the user 120. Instead of, or as well as, keyboard 102 and mouse 104, other input devices, such as touch screens, voice commands, or security systems such as iris, or finger/hand-print sensors can be provided. The computer also has a storage device 106, which stores a database, and a processor 108, which processes the user inputs. In the present embodiment, the computer 100 acts as a detecting component, determining component, generating component and accumulation component.

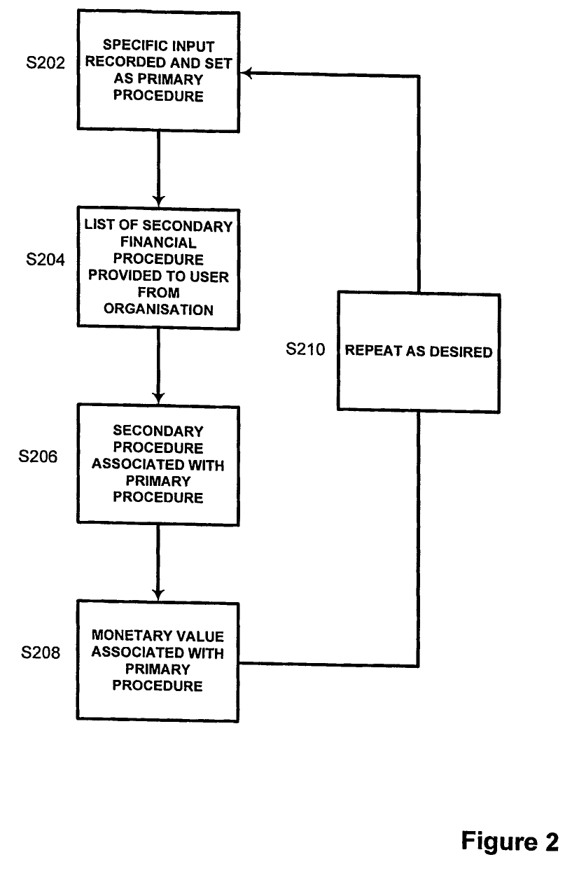

A method of initiation of the computer in the system of FIG. 1 will now be described with reference to FIG. 2.

Initially, the system is configured. At S202, specific user inputs into the computer are recorded by a software agent running on the computer. The software agent may be run automatically at all times, or may be manually activated by the user. This recorded user input combination is assigned as a specific primary procedure and stored in an events register. The user input can be any set of inputs, such as keystrokes, mouse functions and/or voice commands etc, which might, for example, normally cause the opening of a program on the computer. Alternatively, the predetermined key combination might have no other designation for the computer. Additionally, the inputs may be combined with a time requirement, such that the input only acts as a primary procedure between certain preset times. This would allow inputs made in office hours, for example, to be differentiated from those made outside office hours.

Alternatively, the primary procedures may be input from a list of choices supplied to the user by the software agent. For example, the primary procedure might be set to be a predetermined number of keystrokes entered in a word-processing program. The predetermined number of words could be input on an input screen of the software agent. As a further alternative, the primary procedure may be detection of a program being activated for more than a predetermined duration. In this case, once again, the agent presents a list of options to the user, who chooses a duration to be the trigger as the primary procedure. In addition, the primary procedures may be set so as to only be active for certain periods of certain days. It is possible that the computer receives instructions on when the primary procedures are to be detected and cause the secondary procedures. Alternatively, the time data can be set, stored and acted on locally.

In the present embodiment, the primary procedure is non-financial in nature, and is not a procedure normally associated with a financial procedure, i.e. it is unrelated to financial procedures.

The user is then given a choice of recipients from which to choose at S204 from the organisation. In the present embodiment, more than one recipient may be chosen by the user for each primary procedure. Also, the recipients are charitable causes. The list of recipients is provided from a web site accessed by the agent and provided to the user. The user can then associate a particular recipient for a particular primary procedure. Alternatively, the recipients may be any other party that the user chooses, such as relatives, or may even be separate accounts of the user, for one, some or all primary procedures.

At S206, each chosen recipient is associated with the particular selected primary procedure. This association is then stored in the database. The database is accessible to output an associated recipient when the database is queried with a particular primary procedure. That recipient will be determined from this association, every time that the primary procedure is detected.

At S208 a monetary value is input for each chosen recipient assigned to that primary procedure. This information is also stored in the database. The database also holds information on how the monetary value is transferred to the recipient during operation of the system. The combined information, when implemented, provides a secondary financial procedure.

The method can be repeated as desired at S210 to input further primary procedures and associate further secondary financial procedures therewith.

Additionally, one of the primary procedures assigned may be a dedicated icon or “button” shown on the screen of the computer of the user, which, when selected, causes a specified secondary financial procedure to occur “on demand” as required by the user.

In an alternative embodiment, the association details are stored on an association database at the organisation, rather than in the user's computer. In this case, when a primary procedure is detected, the database at the organisation is queried to obtain an associated secondary procedure, which is returned to the computer.

The secondary financial procedures may also be pre-payment for goods or services not yet acquired, when using a good or service, the use of the good or service being the primary procedure. For example, when the internet is used, the secondary financial procedure may be a transfer into an account for future payment for the connection to the internet. Alternatively, the primary procedure may be a broadcast to the user, where the user has preassociated the actual broadcast with a secondary financial procedure.

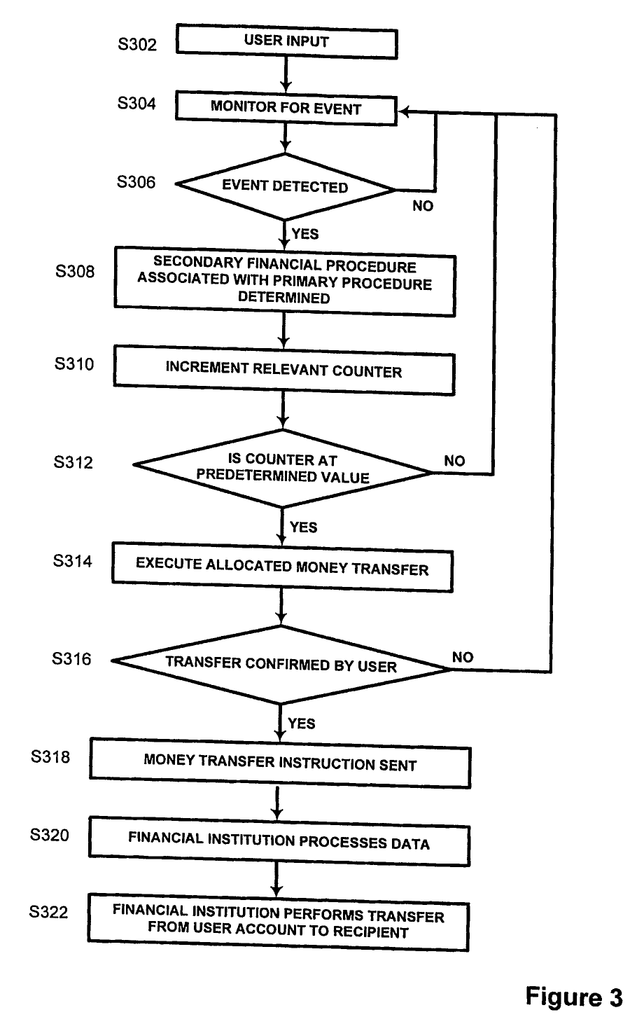

FIG. 3 shows a method of operation of the system shown in FIG. 1. A software agent, as described in relation to FIG. 2 above, is activated either automatically, for example on starting the computer, or manually. The agent enters a terminate, but stay resident, state. In this state the agent is always active, monitoring and comparing inputs to the primary procedures stored in the events register. At S302, a user makes an input. At S304 the software agent monitors inputs into the computer from the user. If, at S306, no primary procedure is detected for a particular input, the software agent returns to S304 to await a further input.

When a primary procedure is detected as having been input into the computer by the user at S308, a secondary financial procedure, associated with the primary procedure, is determined. The secondary financial procedure involves acting on the information stored in the database related to the primary procedure. The database is checked for the recipient(s) and monetary amount(s) associated with the primary procedure.

Once the recipient and monetary amount associated with the detected primary procedure has been found from the database, the secondary financial procedure is executed. The execution of the secondary financial procedure includes allocation of the monetary amount associated with the detected primary procedure to the recipient associated with the detected primary procedure. This is carried out at S310 by incrementing a counter associated with the recipient held on the personal computer by the value associated with the primary procedure, the value of the counter representing a total monetary value. A separate counter is provided for each recipient. The counters are kept secure within the software agent so that they cannot be altered except through the detection of primary procedures. This is done by encryption at database level, as is known in the art.

At S312, whether the relevant counter has reached a predetermined value is determined. If it has not, the software agent returns to monitoring for primary procedures at S304. However, once the counter value reaches a certain predetermined monetary value assigned to the particular recipient, at S314, a money transfer action is executed so that money corresponding to the value held in the counter is transferred from the user of the system to a recipient.

At S316, the user is given an opportunity to confirm or decline the money transfer. Alternatively, S316 may be skipped. If the money transfer is confirmed, at S318 an instruction is sent from the computer to a financial institution via the internet. The instruction may be of the form of automatically logging on to a web based banking system and automatically populating the fields, so that only a confirmation need be made by the user, and optionally a security code to confirm the identity of the user. In this case, S316 and S318 are combined into a single procedure. The instruction data includes data indicating the recipient and allocated value data. The instruction may also include a bank code and account number for the recipient, which may be held in the association database, or at the financial institution, in which case the full transfer details are determined when the recipient identification data is received.

At S320 the financial institution processes the received data, and at S322, performs a transfer from a monetary account of the user, to the identified recipient, of the allocated value. The recipient may receive the transfer into an account also held by the financial institution, or into an account held by a third party, or directly to the recipient, e.g. by creation of an automatically generated and posted cheque to the recipient from the user.

In an embodiment, when the secondary procedure is activated when the counter is at the predetermined monetary value, the value held in the counter is transferred to more than one recipient in a predetermined manner. The details of the recipients and relative amounts would be held on the association database. In the present embodiment, the transfer would be carried out by sending data representing two separate recipients and two amounts when the secondary transfer is executed.

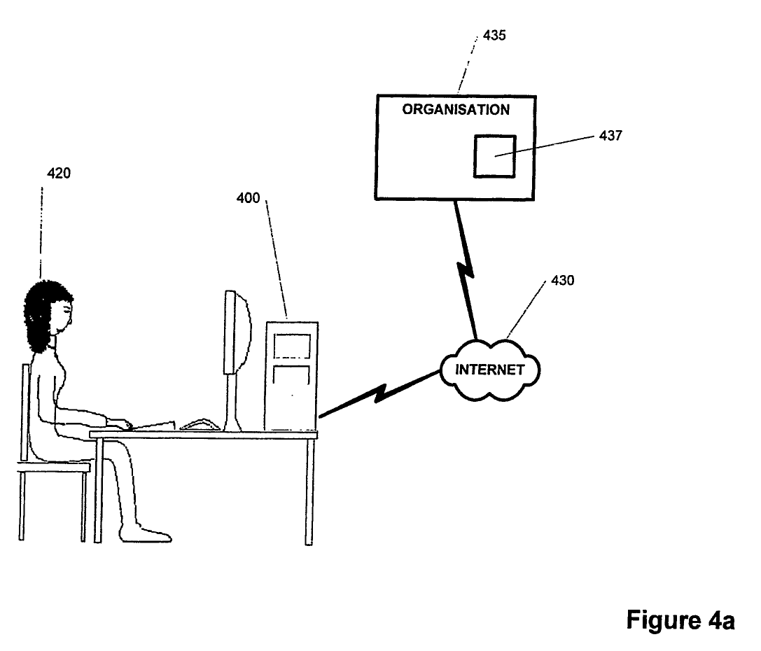

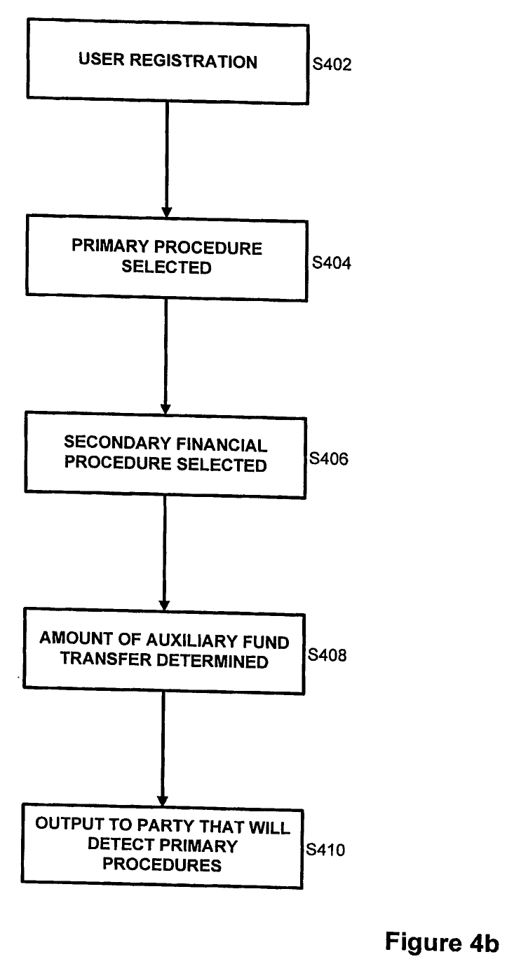

FIG. 4a shows a system for initiation for a further embodiment of the invention. As in FIG. 1, a computer 400 is provided, which a user 420 uses to connect to the internet 430. An organisation 435 is provided, also connected to the internet 430. In this embodiment, the organisation 435 holds an association database 437 containing a list of recipients, from which the user can choose, together with a list of primary procedures from which the user 420 can choose, which are provided from the organisation to the user via the internet 430.

FIG. 4b shows a method for initialisation which may be used with the system shown in FIG. 4a. At S402, if a user is not already registered, the user registers for the service on a website provided by the organisation over the internet. In the present embodiment, the registration includes entering details regarding the identity of the user together with any other information that may be requested by the organisation, such as a password etc. Depending on the particular way the system will be configured, as described below, extra information, such as banking details, may be required, to be used in order to identify the user during a transaction.

At S404, the user is provided with a list of possible primary procedures. The primary procedures may be split into different kinds.

The primary procedures may be a list of different entities, such as vendors. In this case, a number of different vendors would be available. Payment to any one of the vendors could be set to be a primary fund transfer. For example, payment to an electricity company could be set as a first primary procedure, payment to a telephone company, a second and payment to a petrol company a third. The vendors are identified by a unique identification. When a credit/debit card transaction is to be executed to make a payment to the entity, such as from a petrol company, a merchant ID is used to identify the entity. The vendors may also be identified by their payment bank code and account number. For example in the case of an electricity company, payment of an electricity bill as the primary procedure would then be identified by the electronic payment, or direct debit carried out, as these will utilise the bank code and account number as the unique identification of the vendor.

The payments may also be sorted by type of good or service purchased with the payment. In this case, a list of goods and services are supplied to the user, and individual or groups of these are chosen by the user to represent each primary procedure when they are purchased. Many different goods or service may be purchased in the same payment, and each different good or service in a single payment can cause a primary procedure to be detected, as described below. Additionally, one of the possible primary procedures may be withdrawl of funds, for example from an ATM.

Once each primary procedure is selected, at S406 a secondary financial procedure, or auxiliary fund transfer, is associated with it, by the user. The user is provided with a list of recipients for the auxiliary fund transfer, and may, in addition provide their own recipients. The auxiliary fund transfers may be charity donations, or contributions to a third party, e.g. a relative, or may be a contribution to the user, themselves, for example to a holiday fund.

Optionally, additional data such as a time frame in which primary procedure is to act as a trigger for an auxiliary fund transfer can be input. For example, certain primary procedures could be active only in the period before Christmas, so that Christmas shopping caused auxiliary transfer to a charity concerned with providing Christmas presents for low income families. At another time of year, the same purchases could be set to benefit a different recipient charity.

At S408, an amount to be transferred in the auxiliary fund transfer is determined. The amount may be a user defined fixed amount, may be a proportion of the total amount spent in a payment or may be a proportion of each primary financial procedure. Once again, this may be set so as to vary with time.

Finally, at S410, the completed association data, including user identification data, primary and auxiliary fund transfer data, auxiliary transfer amount data and any other data, such as active period data, are transferred from the organisation to the party that will detect when primary procedures are made, as described below. In this case, the organisation is a central coordination centre, which processes all primary procedures and outputs the results of the user association to the party that is appropriate for the chosen primary fund procedure. For example, where the primary procedure is a purchase from a particular entity such as an electricity company, then a financial institution used by the user, and from which such primary fund transfers are to be made, will be informed of the association, will receive the association data and will monitor for primary fund transfers to the particular identified entity, for example an electricity bill. Where the primary procedure is a purchase, all entities, i.e. vendors selling the particular good or service, which are involved in the system are informed of the user association of primary procedure (purchase) with auxiliary fund transfer, and each entity will then retain the association data and monitor for such a primary procedure.

In this way, a number of different types of primary procedure may be entered at a central point (the organisation, on the provided web site) and acted upon. Alternatively, the organisation may be the party that will detect the primary fund transfer, in which case S410 may be omitted.

The initialisation may be completed by many different users, each user being able to individually configure their own primary and secondary procedures independently. Additionally, once initialisation is complete, a user may revisit the configuration website and change their preferences. In this case, at S402 the user logs on with an already identified password, rather than reregistering. From there, the configuration is the same as when initialising, with the exception that the previous preferences are shown as the default, and these can be left unchanged, or amended, as desired. If the association data has been exported to a financial institution or entity, then the updated information is sent with a newer time stamp, and the entity/financial institution association database is updated.

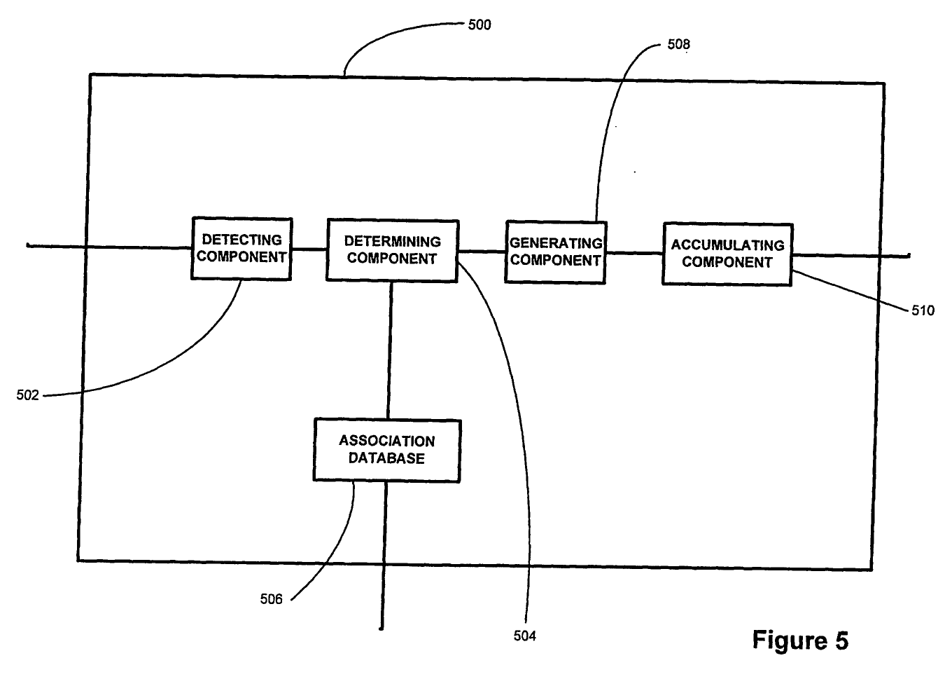

FIG. 5 shows a system for use in embodiments of the invention. The system 500 has a detecting component 502, which detects primary procedures when they are instigated by a user in an electronic environment. The detecting component is connected to a determining component 504, which determines a secondary financial procedure that has been preassociated with the instigated primary procedure by the user. The determining component is connected to an association database 506, which stores the association data transferred from the organisation. Alternatively, the association database may be remote to the system (for example held by the organisation) and accessed only when necessary. A generating component 508 is provided, which generates for output data representing instructions to cause the preassociated secondary financial procedure on detection of the instigated primary procedure. An optional accumulation component 510 is provided in the present embodiment, which, when present, accumulates occurances of the secondary financial procedure, before causing a financial transfer to occur.

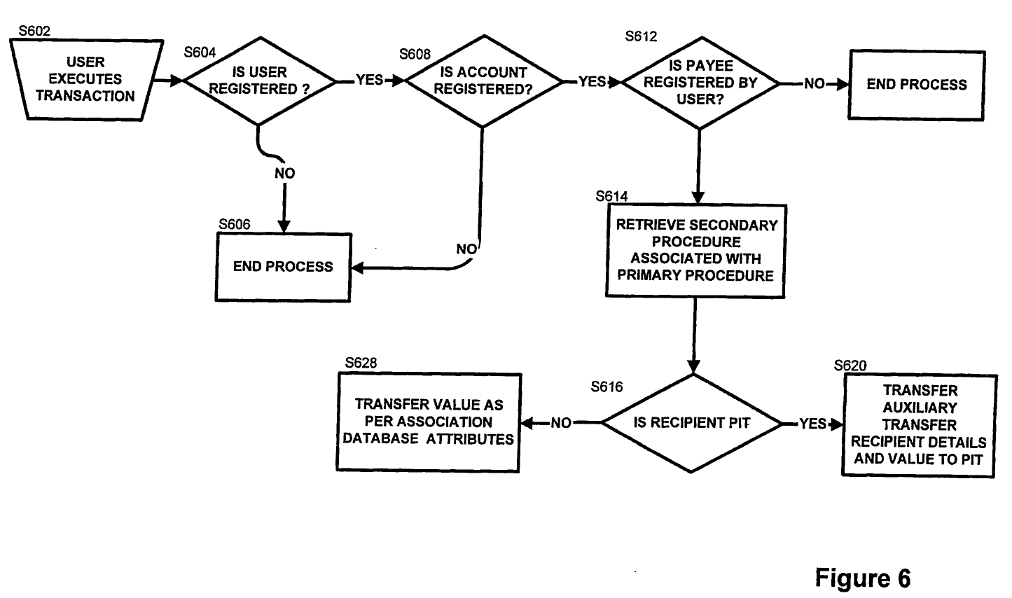

FIG. 6 shows a method of operation of an embodiment of the invention which can make use of the system of FIG. 5, in which case the system is within the financial institution, and association database data is transferred from the organisation to a financial institution responsible for effecting payments for the user after the configuration or initialisation step has been completed. Alternatively, the association database may be remote to the system and connected to the system only when required.

At S602, the user executes a transaction. At S604, the financial institution checks whether the user is registered on the association database, if not, the process is ended at S606. If the user is registered, the user account (e.g. credit account, debit account, particular bank account) is checked as being one that is registered in the association database at S608. At the same time, the details are stored of the registered user transaction. If the user account is registered, this information is also stored. If the user account is not one that is registered then the process ends. If the user account is registered, whether or not the payee is registered in the association database is checked at S612. If the payee is not registered, once again the process ends. If the payee is registered, at S614, the preassociated secondary financial procedure data stored in the association database is interrogated to find the particular recipient in this case, together with the amount to be transferred in the auxiliary fund transfer. The amount may be a proportion of the total value of the primary fund transfer, or may be a fixed amount. At S616, the financial institution checks whether a public interest trust is to be used to hold auxiliary funds for recipients. If a public interest trust is not to be used, the financial institution causes the execution of the auxiliary fund transfer to the chosen recipient for the desired amount. All or some of the details of the process may be stored for the reference for the user and/or the financial institution.

The transaction may be by credit card, or may be by cheque or electronic payment. The identification of the party receiving the funds is known by identification details. As described above, these may be a mechant ID, for example, in the case of a credit or debit card purchase, or bank code and account number, for example, in the case of a cheque or electronic bank payment or direct debit.

Where a public interest trust is to be used, at S620, the auxiliary fund transfer is sent to the trust, together with details of the transfer recipient and amount. Instead of the user paying the auxiliary transfer amount, this could be paid by the financial institution, or by a third party that has previously agreed to pay when certain primary procedures are carried out by the user.

The public interest trust holds money for a preset period of time, in order to recoup costs from interest payments on the held amounts. Generally, any profits made are re-channelled into the causes represented by the trust. The trust receives the money from the financial institution, together which the intended recipient. Once the funds have been held for a sufficient period of time, they are sent to the intended recipient.

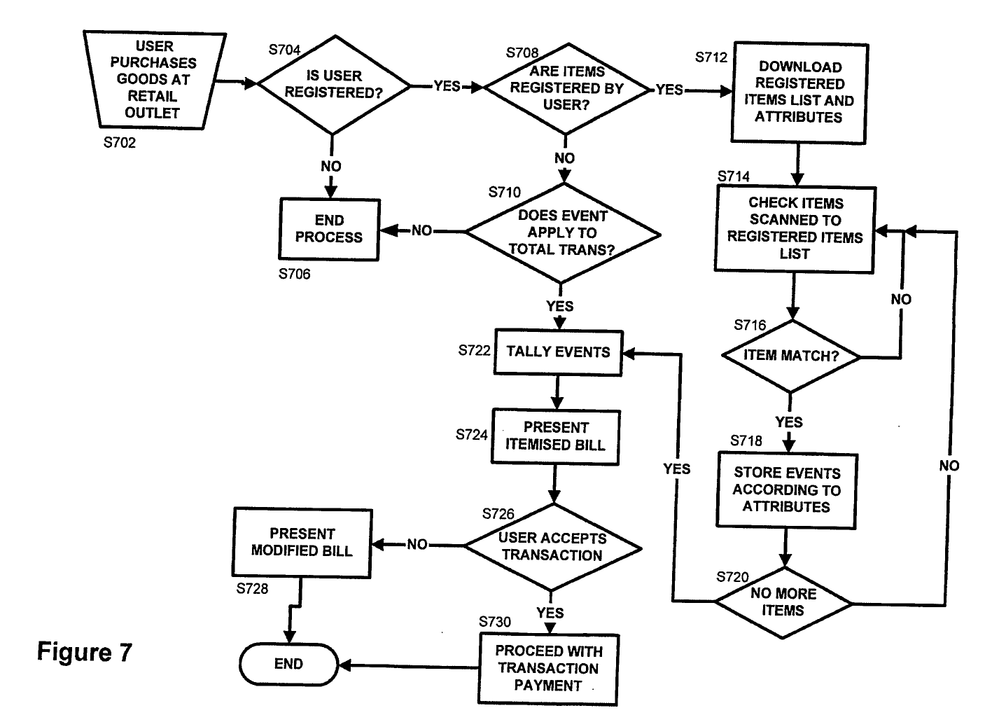

FIG. 7 shows a method of a further embodiment of the invention, which may make use of the system of FIG. 5, in which case the system is part of the vendor systems and the association database data has been transferred to the vendor. This embodiment is for puchases of particular goods and/or services from entities such as vendors. In the present invention, purchase of goods will be described. However, it will be appreciated that the embodiment would apply equally to purchase of multiple services. At S702, the user purchases goods from the vendor. At S704, the vendor checks the association database as to whether the user is registered. If the user is not registered on the association database, the process is ended at S706. If the user is registered, the system checks whether any of the goods purchased are held on the association database at S708. If none is registered, the system checks, at S710, whether the association database is set to trigger an auxiliary fund transfer on the total amount spent at the particular vendor. If this is not the case, then the process ends. Alternatively, some of the purchased goods are registered, and so the attributes for the registered goods purchased are downloaded from the association database to the checkout at S712. The checkout then checks each of the purchased goods against the association database data at S714. Each good is checked for a match to the database data at S716, and, if it is a match, then the auxiliary transfer associated with the good is stored for action at S718. If there is no match, or after the auxiliary transfer is stored, the process checks if there are more items at S720, and the process is repeated until there are no more items. When there are no more items, or if the auxiliary transfer applies to the total transaction with the vendor, all auxiliary transfers to be made are tallied at S722. An itemised bill is presented to the user at S724, which shows the cost of the goods, and the amounts and recipients of funds to be transferred as auxiliary transfers. The user can accept or decline the auxiliary transfers at S726. If they are declined, a modified bill, giving only the cost of the goods is provided for payment at S728, and the process ends. If the auxiliary transfers are accepted, the total amount is debited from the user to the vendor. The vendor then operates a clearing process to forward all auxiliary fund transfers to the intended recipients on a periodic basis. Alternatively, all auxiliary transfer amounts are transferred to a single body, such as a public interest trust, together with details of the recipient and amount of the auxiliary transfer, and the public interest trust then makes the payments to the recipients in the same way as described with reference to FIG. 6 above. All or some of the details of the process may be stored for the reference for the user and/or the vendor. Additionally, instead of the user paying for the auxiliary transfer amount, the amount can be paid by the vendor.

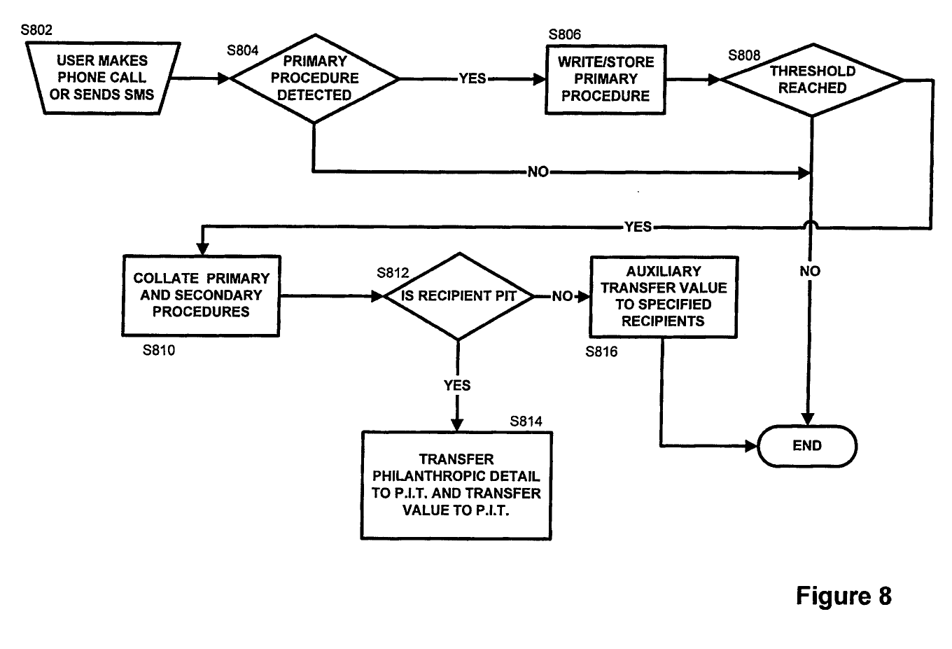

FIG. 8 shows a method of a yet further embodiment of the invention, which again can make use of the system of FIG. 5, in which case the system is part of the telecommunication provider's system. This embodiment relates to telecommunications providers, and the association database data is transferred to the telecommunication provider of the user.

At S802, the user makes a telephone call or sends an SMS message. At S804, the system checks whether this user action is registered as a primary procedure in the association database. If it is not, the process ends. If the action is a primary procedure is stored at S806 in a store and, in the present embodiment a counter is incremented, relating to any procedure, on detection of any primary procedure, and the counter value stored. Alternatively, separate counters could be provided for each particular registered primary procedure. The counter is checked to determined whether it has reached a predetermined threshold at S808, and, if not, this iteration of the process ends.

Once the threshold for the counter is reached, the stored primary procedures are collated with the associated auxiliary transfers stored in the association database at S810. At S812, whether or not the receiving party is a public interest trust is determined. If it is, then at S814 the auxiliary transfer is carried out to the trust, together with details of the amount and recipients to receive the auxiliary transfer. If the receiving parties are simply the recipients stored in the association database, then at S816, the auxiliary transfers are effected to the intended recipients, and this may be through a financial institution, which may in fact, act in much the same manner as in the case of a trust. This embodiment could also be configured to operate on receipt of calls and/or SMS messages. All or some of the details of the process may be stored for the reference for the user and/or the telecommunications company.

The present invention has been described above with the aid of functional building blocks illustrating the performance of specified functions and relationships thereof. The functional building blocks have been arbitrarily defined herein while describing embodiments of the invention. Alternate definitions can be defined so long as the specified functions and relationships thereof are maintained. The invention extends to any such alternate definitions. It will be seen that the functional building blocks can be implemented by application specific integrated circuits, discrete components, processors executing appropriate software and the like or any combination thereof.

Finally, it will be appreciated that various alterations and/or additions may be introduced into the particular construction and arrangement of the method and system of the invention described herein, which extends to individual features and groups of features, without departing from the spirit or ambit of the present invention.

1. A method of giving, the method comprising:
detecting an instigated primary procedure, instigated by a user in an electronic environment;
determining a secondary financial procedure, preassociated by the user with the instigated primary procedure; and
automatically generating for output data representing instructions to cause the secondary financial procedure on detection of the instigated primary procedure.

2. A method according to claim 1, wherein the instigated primary procedure is one of a plurality of primary procedures preassigned by the user as primary procedures.

3. A method according to claim 2, wherein the determined secondary financial procedure is one of a plurality of secondary financial procedures, each secondary financial procedure preassociated by the user with at least one of the plurality of preassigned primary procedures.

4. A method according to claim 1, wherein the instigated primary procedure is non-commercial in nature.

5. A method according to claim 1, wherein the instigated primary procedure is an action on a computer.

6. A method according to claim 5, wherein the instigated primary procedure is a procedure carried out to achieve an effect on the computer other than the secondary financial procedure.

7. A method according to claim 1, wherein the instigated primary procedure is an action on a telephone.

8. A method according to claim 3, wherein the plurality of primary procedures are primary fund transfers for payment in regard to at least one of: at least one entity; at least one good; and at least one service, by the user.

9. A method according to claim 8, wherein the plurality of secondary financial procedures are auxiliary fund transfers to at least one predetermined recipient from the user.

10. A method according to claim 8, wherein the secondary financial procedures are auxiliary fund transfers to at least one predetermined recipient from a third party.

11. A method according to claim 8, wherein the secondary financial procedures are allocations of auxiliary fund transfer amounts.

12. A method according to claim 3, wherein the primary procedure is purchase of at least one of: at least one good; and at least one service.

13. A method according to claim 3, wherein preassociation of primary procedures and secondary financial procedures is made by association, in an association database, of particular entities, goods, and/or services with particular recipients.

14. A method according to claim 13, wherein the association database is stored by an entity selling the good and/or service.

15. A method according to claim 13, wherein the primary procedure is a primary fund transfer from the user for payment in regard to an entity.

16. A method according to claim 15, wherein the association database is held by a financial institution responsible for effecting payments made by a user.

17. A method according to claim 16, wherein the primary procedure is payment to a particular payee.

18. A method according to claim 1, wherein the secondary financial procedure involves an allocation of a predetermined contribution to a recipient.

19. A method according to claim 18, further comprising accruing a plurality of allocated contributions, caused by a plurality of occurrences of the secondary financial procedure, up to a predetermined accrued value, and subsequently causing transfer of a monetary sum having the predetermined accrued value to the recipient.

20. A method according to claim 1, wherein the secondary financial procedure is an allocation of funds to a philanthropic cause.

21. A method of giving, the method comprising:
detecting an instigated primary procedure, instigated by a user in an electronic environment, the instigated primary procedure being a non commercial action on a computer;
determining a secondary financial procedure, preassociated by the user with the instigated primary procedure; and
generating for output data representing instructions to cause the secondary financial procedure,
wherein the primary procedure is carried out to achieve an effect on the computer other than the secondary financial procedure.

22. A method of giving, the method comprising:
detecting an instigated primary procedure, instigated by a user in an electronic environment, the instigated primary procedure being one of a plurality of primary procedures preassigned by the user as primary procedures;
determining a secondary financial procedure, preassociated by the user with the instigated primary procedure, the determined secondary financial procedure being one of a plurality of secondary financial procedures, each secondary financial procedure preassociated by the user with at least one of the plurality of preassigned primary procedures; and
generating for output data representing instructions to cause the secondary financial procedure,
wherein the preassociation of primary procedures and secondary financial procedures is association of particular entities, goods or services with particular recipients in an association database.

23. A method of primary and auxiliary fund transfer, the method comprising:
receiving information relating to a primary fund transfer for payment of at least one entity, good or service;
processing the information and determining a recipient associated with the entity, good or service using an association database; and
generating for output data representing an allocation of an auxiliary fund transfer to the determined recipient.

24. A system for giving, the system comprising:
a detecting component which detects an instigated primary procedure, instigated by a user in an electronic environments;
a determining component which determines a secondary financial procedure, preassociated by the user with the instigated primary procedure, on detection of the instigated primary procedures; and
a generating component which generates for output data representing instructions to cause the secondary financial procedure on determination of the secondary financial procedure.

25. A system for giving according to claim 24, further comprising an association database to store data associating each of a plurality of primary procedures with at least one corresponding associated secondary procedure from a plurality of secondary financial procedures.

26. A system for giving according to claim 25, wherein the association database is arranged to store associations of particular entities, goods and/or services, associated with a particular primary procedure for each of the primary procedures, with at least one particular recipient associated with a particular secondary financial procedure for each secondary financial procedure.

27. A system for giving according to claim 24, further comprising an accumulation component, which receives the instructions to cause the secondary financial procedure, and increments a notional counter on each such receipt.

28. A system for giving according to claim 27, wherein the accumulation component is arranged to output instructions to cause a payment to be effected when the counter has been incremented by a predetermined amount.

29. A system for giving, the system comprising:
a detecting component which detects at least one instigated primary procedure, instigated by a user in an electronic environment, the instigated primary procedure being a non commercial action on a computer;
a determining component which determines at least one secondary financial procedure, preassociated by the user with the instigated primary procedure; and
a generating component which generates for output data representing instructions to cause the secondary financial procedure,
wherein the primary procedure is a procedure carried out to achieve an effect on the computer other than the secondary financial procedure.

30. A system for giving, the system comprising:
a detecting component which detects at least one instigated primary procedure, instigated by a user in an electronic environment, the instigated primary procedure being one of a plurality of primary procedures preassigned by the user as primary procedures;
a determining component which determines at least one secondary financial procedure, preassociated by the user with the instigated primary procedure, the determined secondary financial procedure being one of a plurality of secondary financial procedures, each secondary financial procedure preassociated by the user with at least one of the plurality of preassigned primary procedures;
a generating component which generates for output data representing instructions to cause the secondary financial procedure; and
an association database which stores a preassociation of primary procedures and secondary financial procedures, the association being an association of particular entities, goods or services with particular recipients in the association database.

31. A method of giving, the method comprising:
establishing a primary procedure performed by a user within an electronic environment; and
associating a secondary financial procedure with the primary procedure by the user, such that the secondary financial procedure is activated on operation of the primary procedure.

32. A method according to claim 31, wherein the associated primary and secondary procedures are stored in an association database.

33. A method according to claim 31, further comprising
detecting an instigated primary procedure instigated by a user in an electronic environment;
determining a secondary financial procedure preassociated by the user with the instigated primary procedure: and
automatically generating for output data representing instructions to cause the secondary financial procedure on detection of the instigated primary procedure.

34. A method of giving, the method comprising:
detecting an primary procedure instigated in an electronic environment;
determining a secondary financial procedure, preassociated by the user with the instigated primary procedure; and
automatically generating for output data representing instructions to cause the secondary financial procedure on detection of the instigated primary procedure.

35. A data carrier medium carrying processor readable code to control a processor to carry out the method of claim 1.

36. A data carrier medium carrying processor readable code to control a processor to carry out the method of claim 31.
